(19) United States
(12) Patent Application Publication
(10) Pub. No.: US 2011/0161154 A1
(43) Pub. Date: Jun. 30, 2011

(54) Electronic Management of Reward Credits

(76) Inventors: Michael McLaughlin, Gardnerville, NV (US); Raymond Robertson, Carson City, NV (US)

(21) Appl. No.: 12/651,369

(22) Filed: Dec. 31, 2009

(51) Int. Cl. G06Q 30/00; G06Q 10/00; G06Q 50/00

(52) U.S. Cl. 705/14.26; 705/14.34; 705/14.36

(57) ABSTRACT

In one embodiment a device, method, and system for managing reward credits may have a central reward database configured to record a predetermined set of product codes, a reward credit associated with each product code in the predetermined set of product codes, and a server configured to: (a) receive a redemption request from at least one registered participant, the redemption request including a product code, wherein the product code is provided on a product or product container; (b) access the central reward database to determine whether the product code of the redemption request is authorized and available; (c) determine the appropriate reward credit for the product code if it is determined that the product code of the redemption request is authorized and available; and (d) provide the appropriate reward credit to the at least one registered participant.

### FIELD OF THE INVENTION

The present disclosure relates generally to the management of reward credits. More particularly, the invention relates generally to the electronic redemption, distribution, and management of reward credits.

### BACKGROUND OF THE INVENTION

In ordinary commerce, sellers of goods and services can use coupons to attract or identify specific market segments of consumers to buy the goods or services. Typically, the source of the coupon is either the vendor's own product or publication or that of a distributor or other information provider associated with the vendor. However, the user of paper coupons is a very time consuming, costly, and an imprecise process. Furthermore, paper coupons do not allow manufactures, distributors, or sellers of the goods or services to obtain valuable marking and customer information.

Consumers can take these coupons to their local store to redeem them or return them to their source along with a proof of purchase in order to receive a refund by mail. These methods are both inconvenient and time consuming for the consumer. Currently, there is no effective way to distribute, redeem, and track reward credits or coupons electronically.

### OVERVIEW

Embodiments described herein provide for the electronic redemption, distribution, management of reward credits. A reward credit management site or server may have a database used to record a predetermined set of product codes, a reward credit associated with each product code in the predetermined set of product codes, and at least one participant account associated with the predetermined set of product codes. The server may then access the database to determine whether the product code of a redemption request is authorized and available.

In one embodiment, a system for managing reward credits can have a central reward database configured to record a predetermined set of product codes, a reward credit associated with each product code in the predetermined set of product codes, and at least one participant account associated with the predetermined set of product codes. A server may be configured to: (a) receive a redemption request from at least one registered participant, the redemption request including a product code, wherein the product code is provided on a product or product container; (b) access the central reward database to determine whether the product code of the redemption request is authorized and available; (c) determine the appropriate reward credit for the product code if it is determined that the product code of the redemption request is authorized and available; and (d) provide the appropriate reward credit to the at least one registered participant.

In one embodiment a method for redeeming reward credits may include receiving, at a server, a redemption request from at least one registered participant, the redemption request having a product code associated with a product or a product container and accessing a central reward database to determine if the product code is authorized and available, and locate a reward credit associated with the product code if the determining determined that the product code is authorized and available. The reward credit may then be provided to the at least one registered participant.

In yet another embodiment, a method for redeeming reward credits may include obtaining, by a registered participant, at least one product having an associated product code, accessing a reward credit management website having a central server, entering the associated product code for transmission to the central server, and receiving a reward credit associated with the product code.

In another embodiment, a program storage device readable by a machine tangibly embodying a program of instructions executable by the machine to perform a method for managing reward credits may comprise configuring a central reward database to recognize a predetermined set of product codes, subsequently receiving a redemption request from a registered participant, the redemption request including a product code provided on a product or product container, determining whether the product code of the redemption request is authorized and available, determining the appropriate reward credit for the product code if the determining determines that the product code of the redemption request is authorized and available, and providing the appropriate reward credit to the registered participant.

These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIG. 1 is a block diagram of an example reward credit management system.

FIGS. 2A-2C illustrate example screen shots for the submission of a redemption request.

FIGS. 3A and 3B illustrate flow diagrams of an example method for redeeming reward credits.

FIG. 4 illustrates a flow diagram of an example method for purchasing a prize using reward credits.

FIG. 5 illustrates a flow diagram of an example method for obtaining reward credits by a seller.

FIGS. 6A-6I illustrate example screen shots for managing reward credits.

FIG. 7 illustrates a flow chart of an example method for redeeming reward credits.

FIGS. 8A-8C illustrate example screen shots for redeeming reward credits by a customer.

FIG. 9 illustrates a flow chart of an example method for redeeming a prize using reward credits.

FIGS. 10A-10C illustrate screen shots of example prizes available for redemption with reward points.

FIG. 11 illustrates a flow chart of an example method to detect reward credit redemption fraud.

FIGS. 12A-12C illustrate example screen shots for an audit of a customer.

FIGS. 13A-13B illustrate example screen shots to obtain customer information.

FIG. 14 illustrates an exemplary computing system.

FIG. 15 is a block diagram of an example computing system.

### DESCRIPTION OF EXAMPLE EMBODIMENTS

Embodiments are described herein in the context of electronic management of reward credits. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The components, process steps, and/or data structures may be implemented using various types of operating systems, computing platforms, computer programs, and/or general purpose machines. Embodiments of the invention can, for example, be implemented by software, hardware, or a combination of hardware and software. Embodiments can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Embodiments described herein provide for the electronic redemption, distribution, management of reward credits. A reward credit management site or server may have a database used to record a predetermined set of product codes, a reward credit associated with each product code in the predetermined set of product codes, and at least one participant account associated with the predetermined set of product codes. The server may then access the database to determine whether the product code of a redemption request is authorized and available.

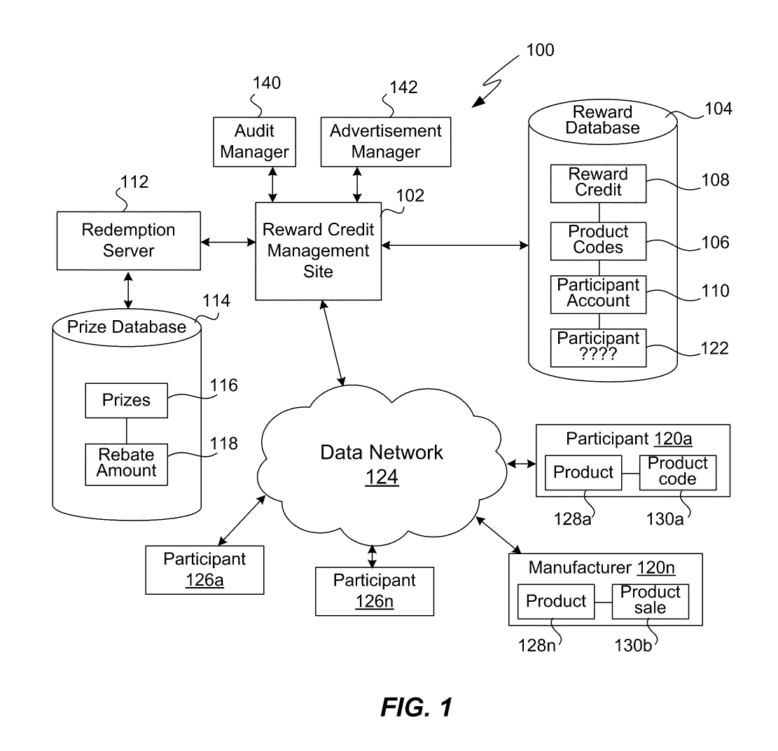

Referring now to FIG. 1, an example block diagram of a reward credit management system. The reward credit management system 100 includes a reward credit management site 102. In one embodiment, the reward credit management site 102 may be a server. The reward credit management site 102 can coordinate submission (receipt) of redemption requests and rebate requests, transmission and updating of reward credits, transmission of prizes, updating of participant information and accounts, and any other functions necessary to carry out the embodiments described herein.

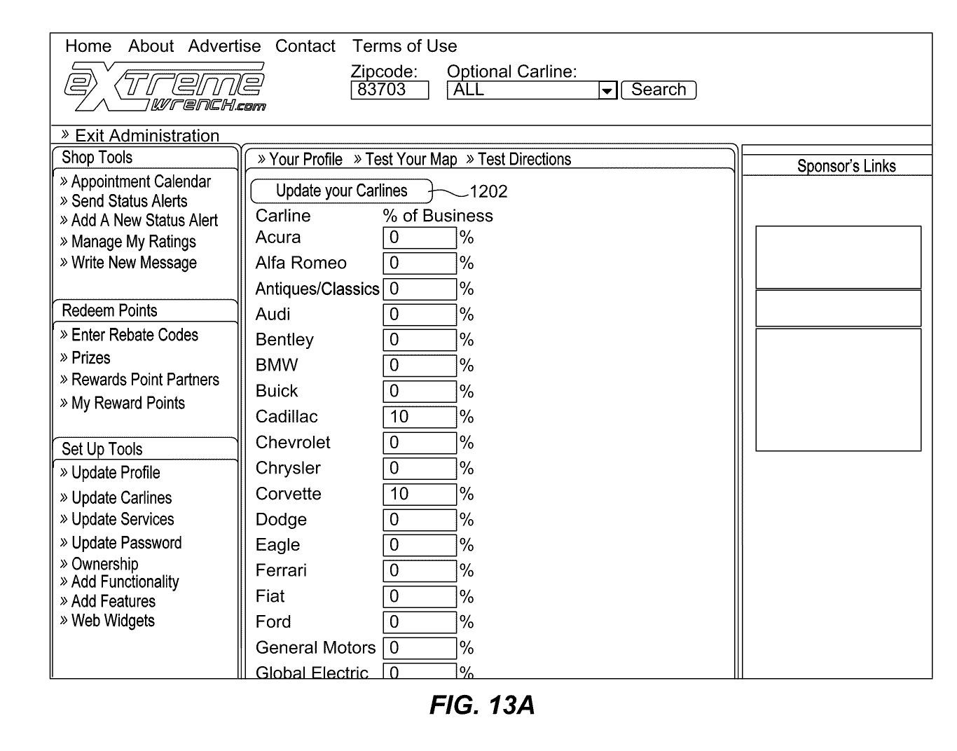

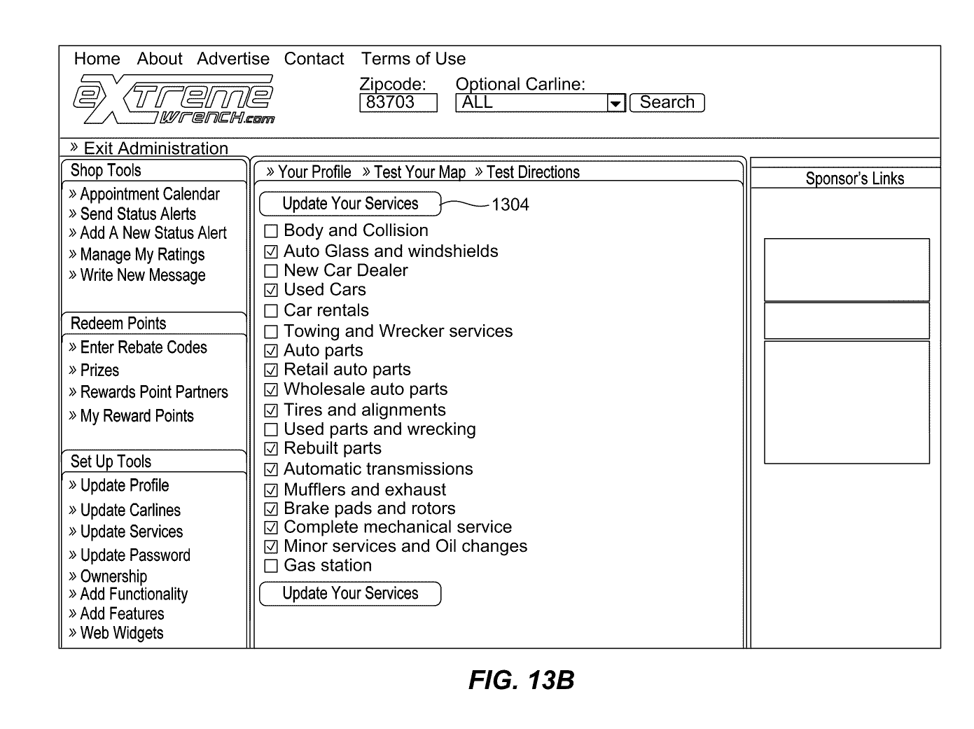

The system 100 may also have a reward database 104. The reward database 104 may provides mass storage and record numerous predetermined set of product codes 106, a reward credit 108 associated with each product code in the predetermined set of product codes, and at least one participant account 110 associated with the predetermined set of product codes 106. The reward database may also store participant information 122, such as shop information as discussed in detail below with reference to FIGS. 13A and 13B. Although illustrated with the reward database 104 configured to store the above information, this is not intended to be limiting as the above information may be stored in multiple databases.

The system 100 may also have a redemption server 112. The reward credit management site 102 may be configured to present a list of prizes and its associated rebate amount to the participants 120a-n, 126a-n. The redemption server 112 may have a prize database configured to store the list of prizes 116 and its associated rebate amount 118. The rebate amount may be set by a first participant 120a-n (where n is an integer), such as a manufacturer, distributor, or any other participant which provides goods or services to customers. In one embodiment, the first participant 120a-n is a manufacturer or distributor of automotive goods. Reward credits can be purchased or redeemed at the reward database 104 or the redemption server 112 over a data network 124 by way of the reward credit management site 102.

The reward credit management system 100 can include a first participant 120a-n and a second participant 126a-n. Typically, the reward credit management system 100 would include a plurality of different participants 120a-n, 126a-n. In one embodiment, the first participant 120a-n may be a manufacturer, distributor, vendor or any other participant which provides goods or services to customers. The second participant 126a-n may be any client which purchases the goods or services from the first participant 120a-n, such as consumers, store or shop owners, and the like. In one embodiment, the first participant 120a-n may be a manufacturer of automobile goods and the second participant 126a-n may be an automobile shop or automobile repair store. In another embodiment, the first participant 120a-n may be a vender of automobile goods and the second participant 126a-n may be a consumer purchasing the automobile goods. The first participant 120a-n may have a plurality of products 128a-n. Each of the plurality of products 128a-n may have an associated product code 130a-n. The first participant 120a-n can be coupled to the reward credit management site 102 through the data network 124. Hence, any of the first participants 120a-n can interact with the reward credit management site 102 to review, purchase, redeem and/or manage their reward credits.

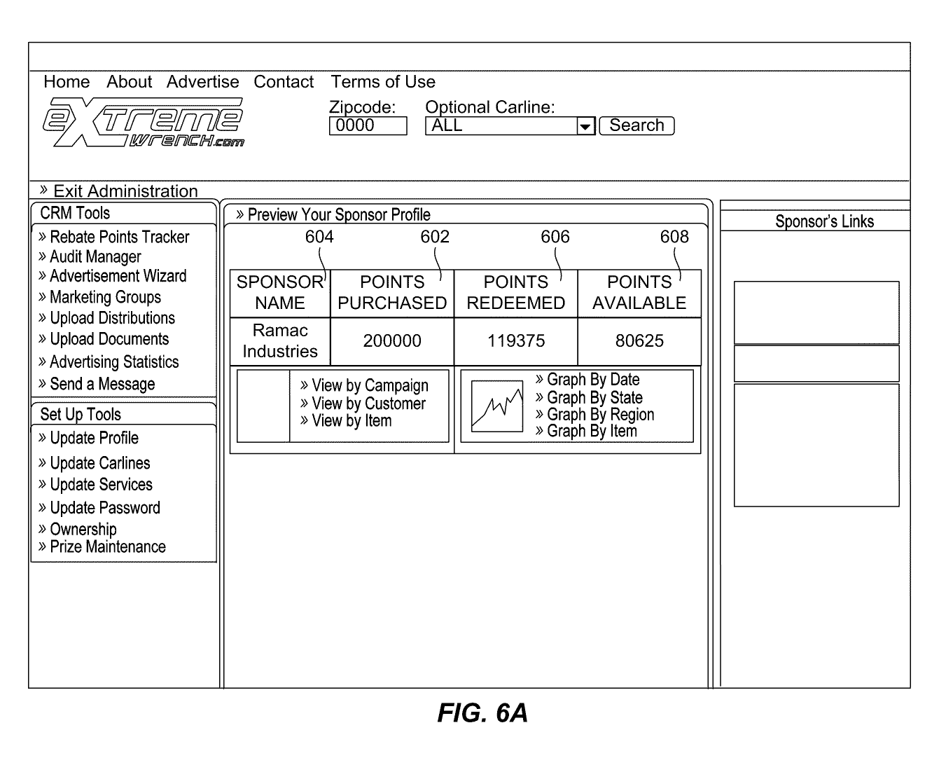

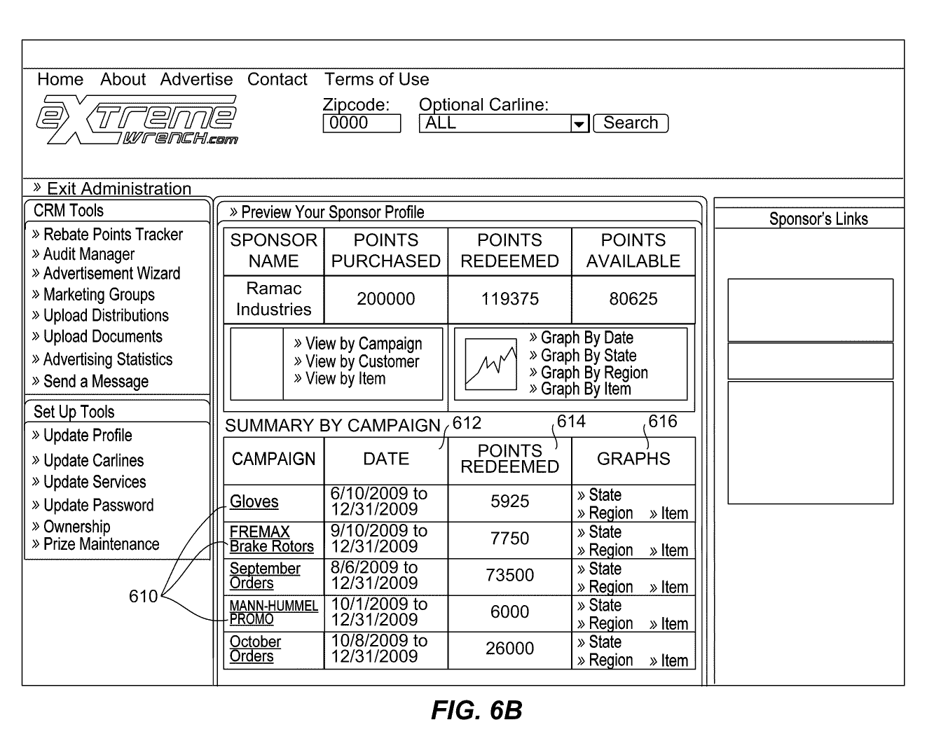

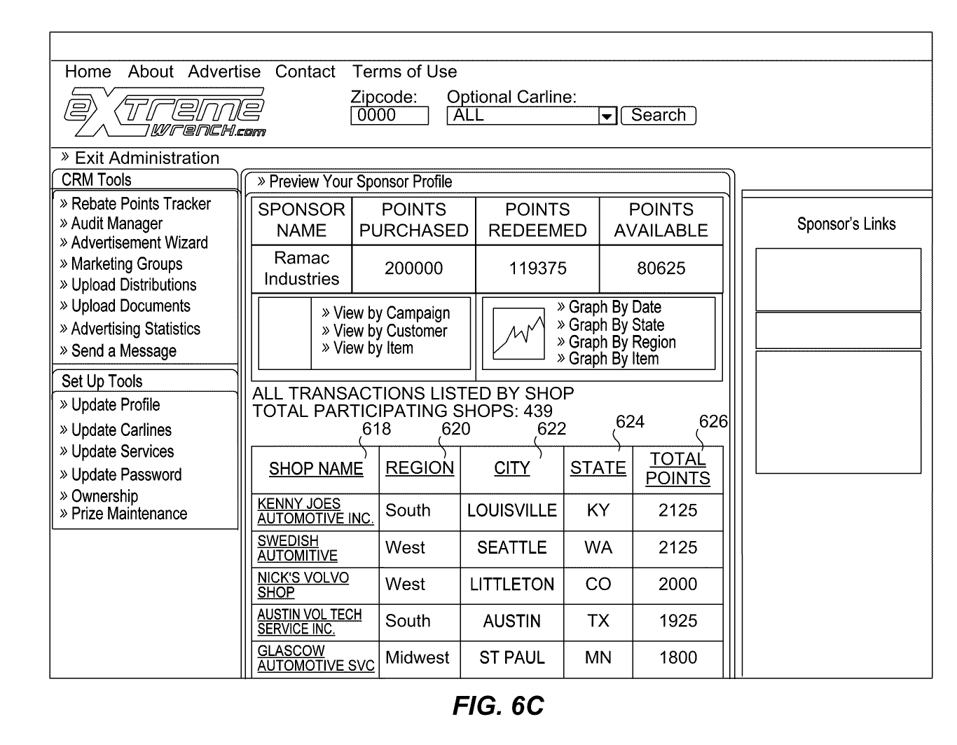

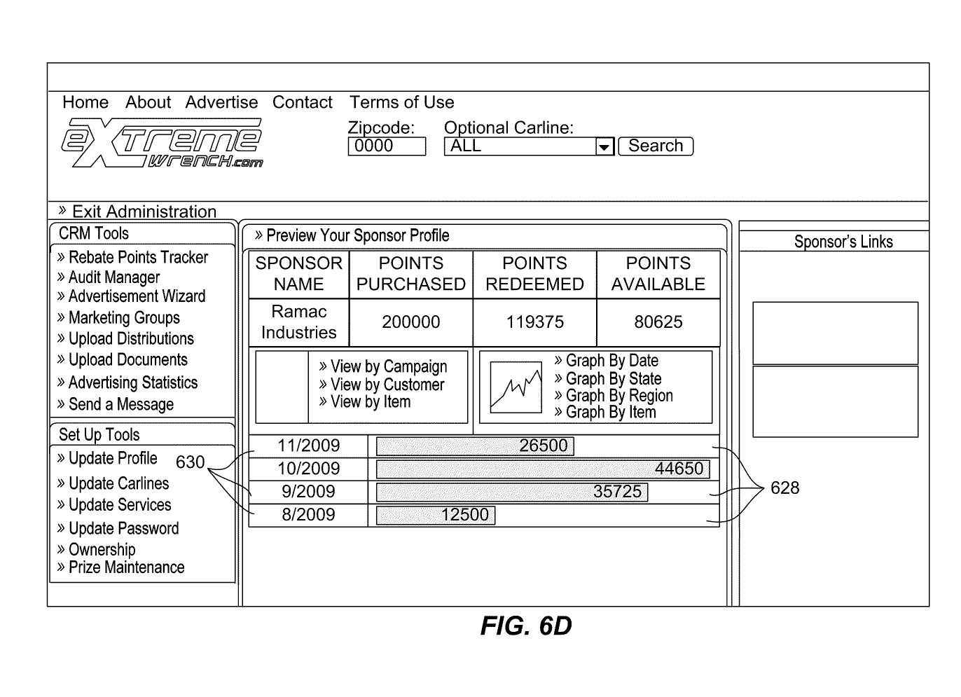

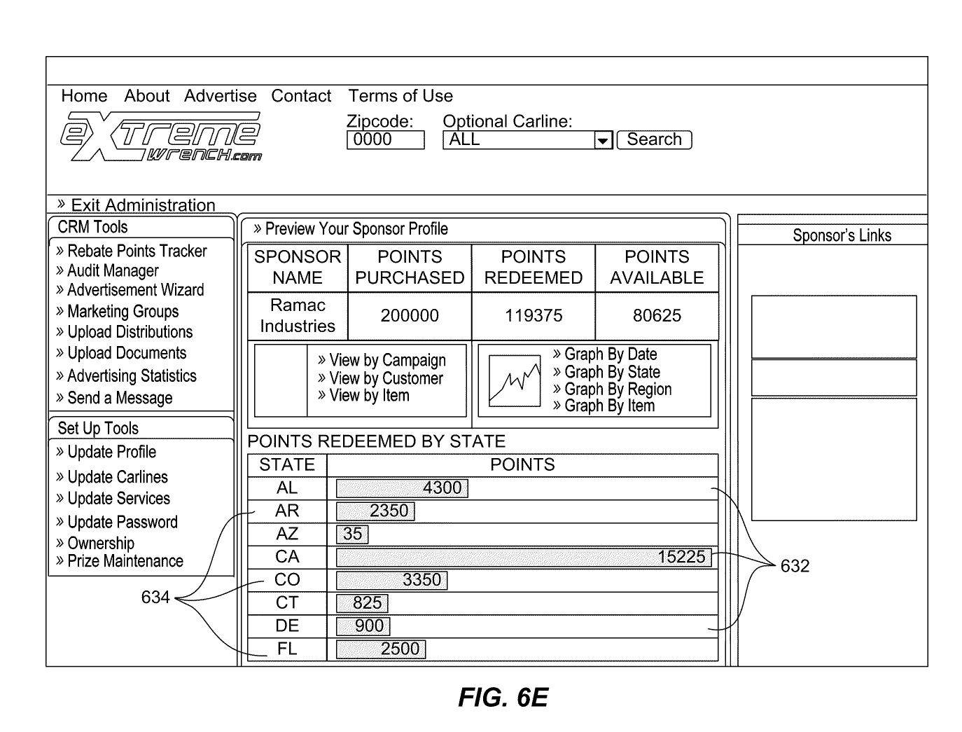

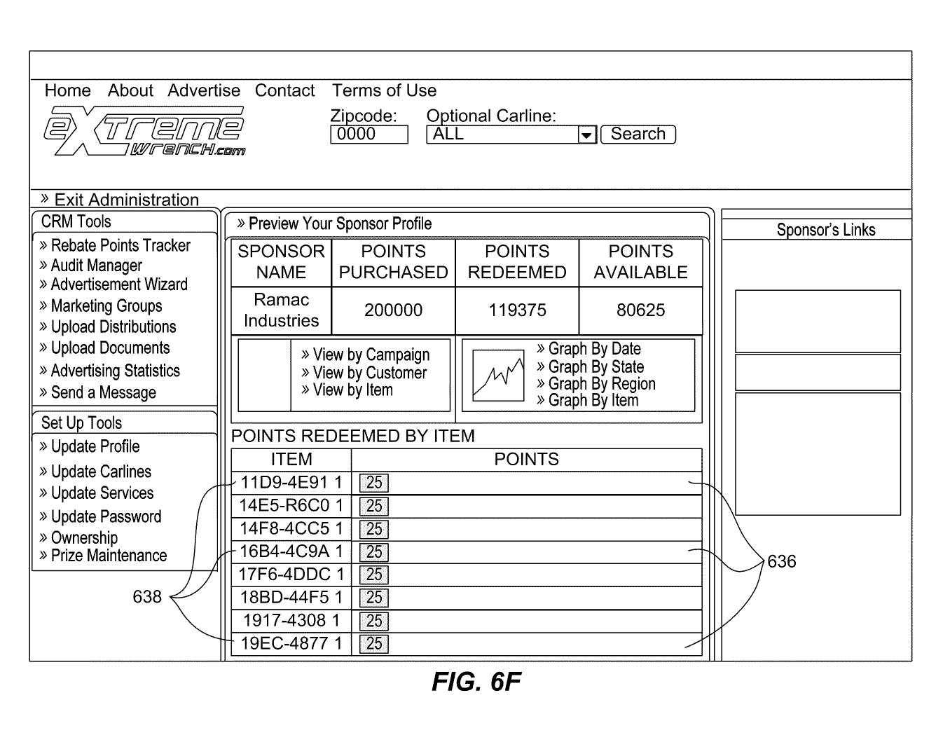

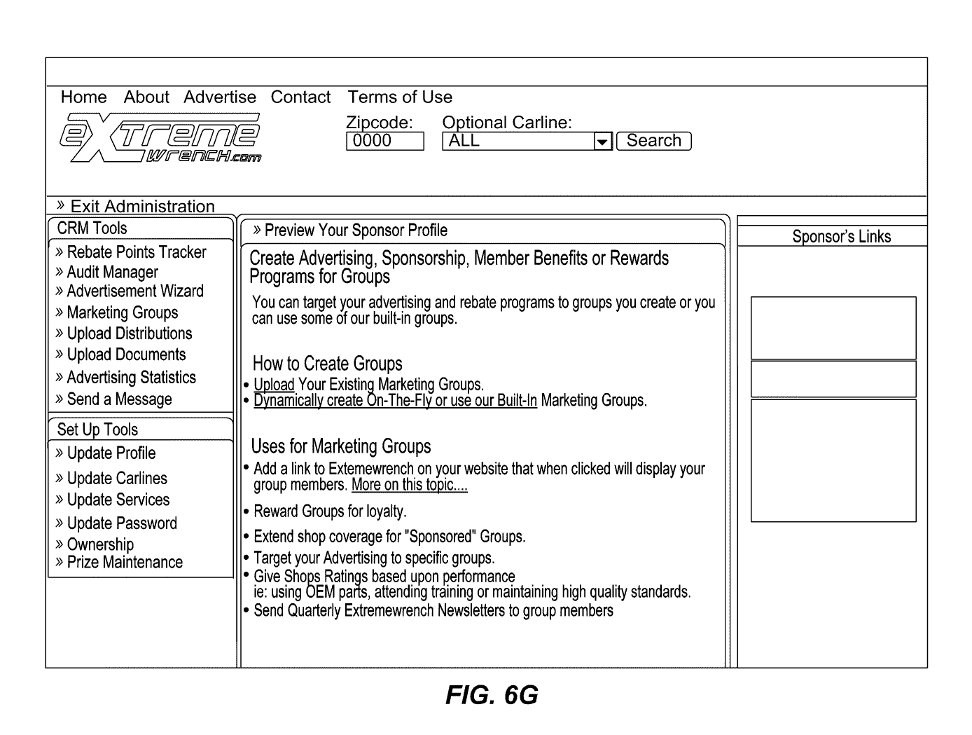

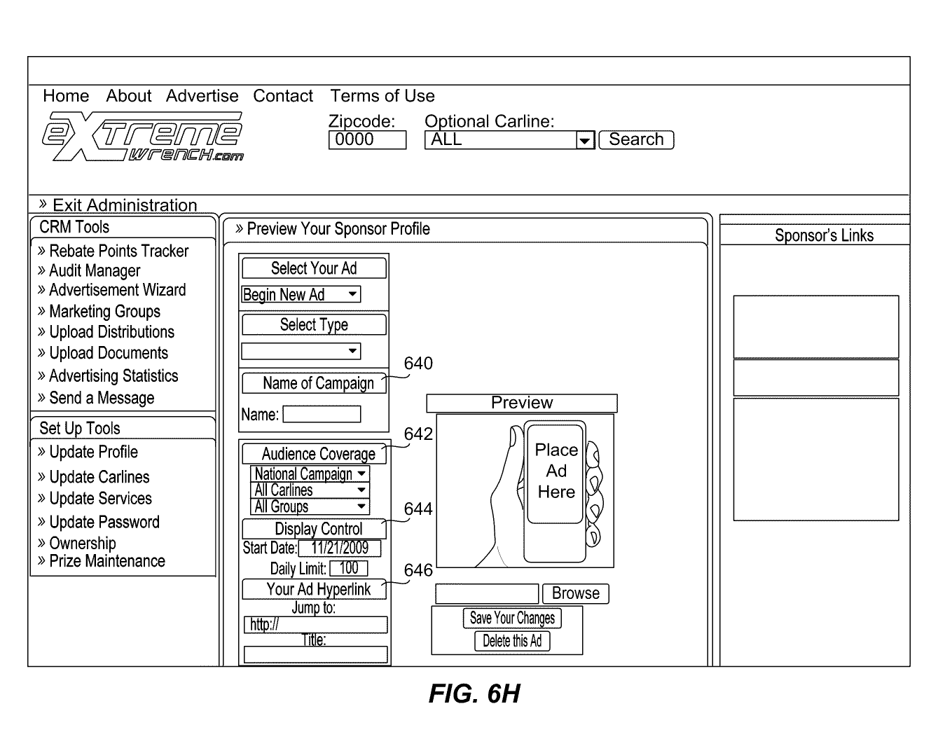

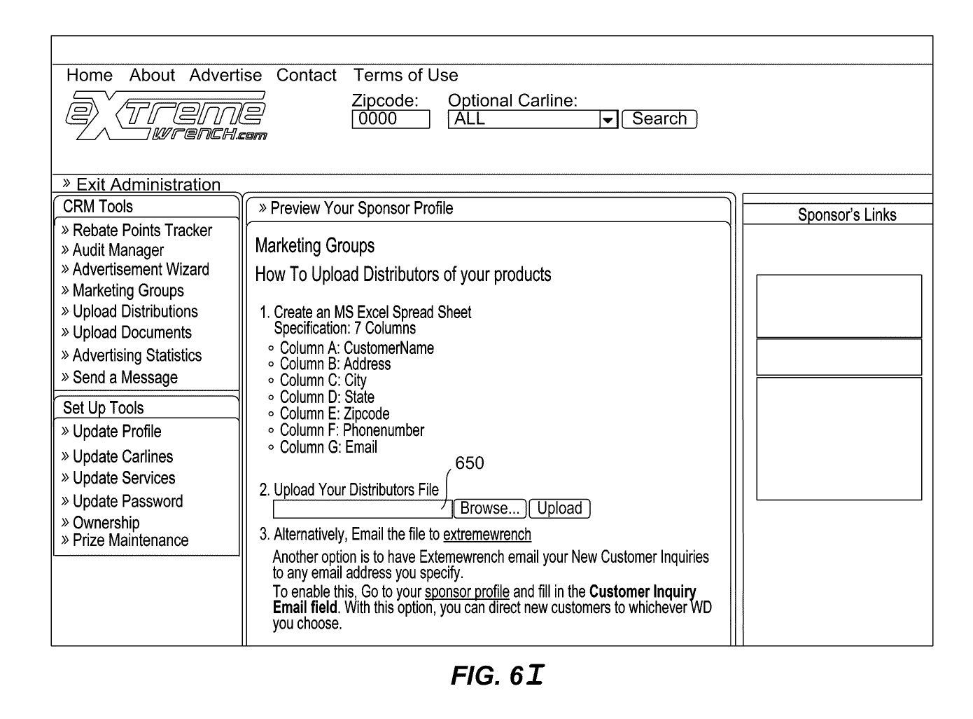

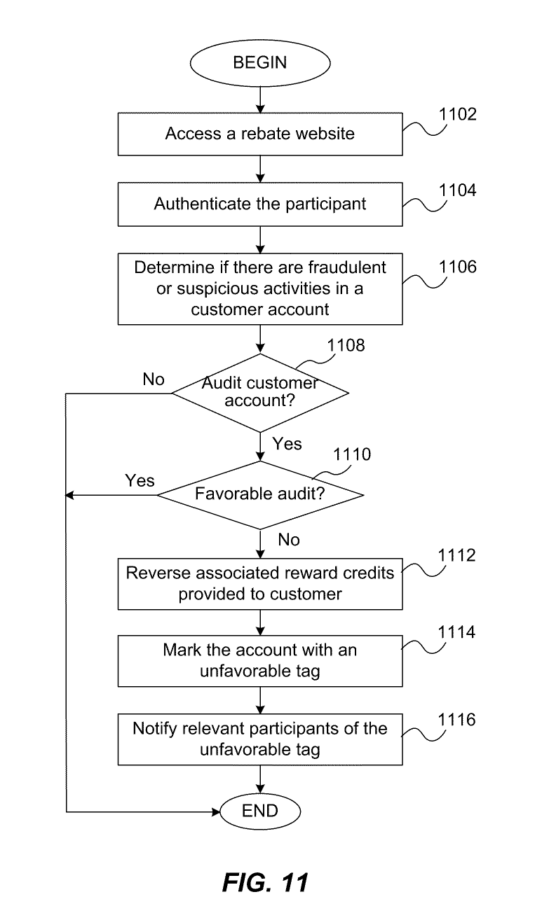

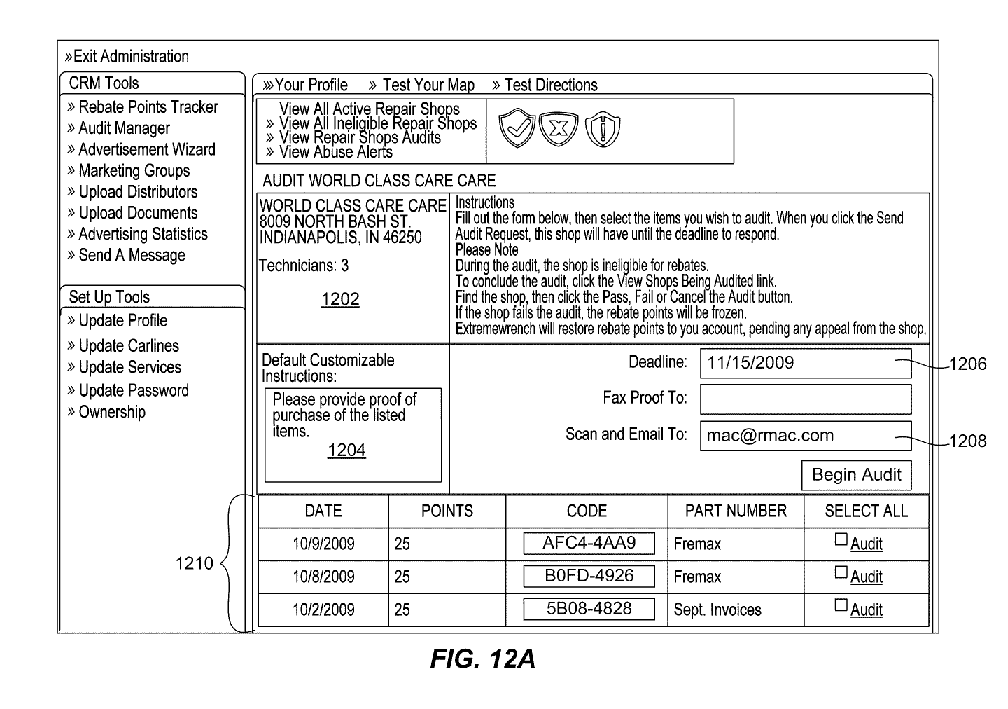

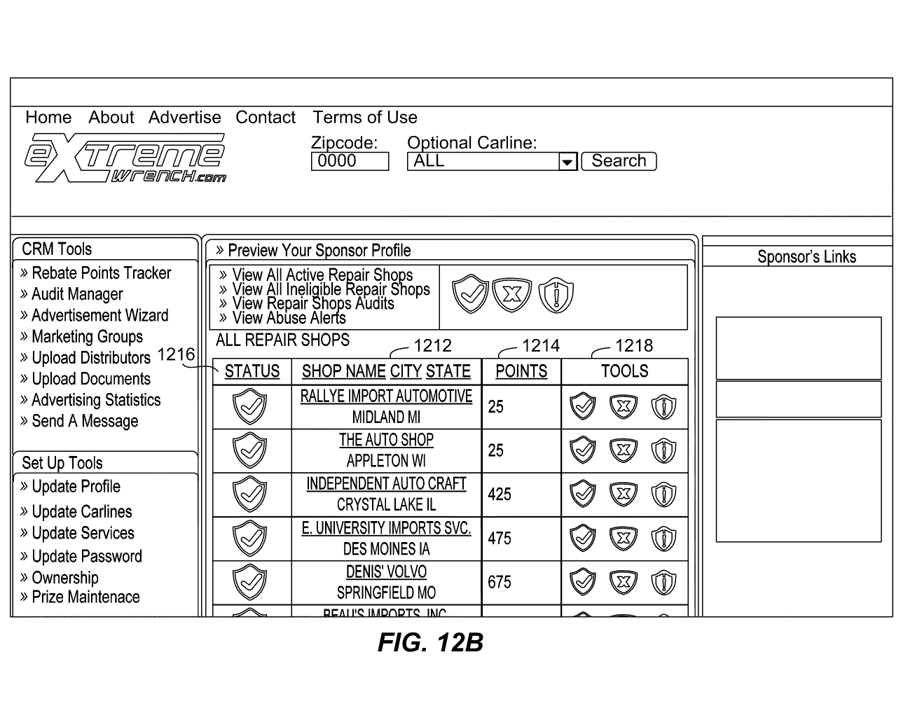

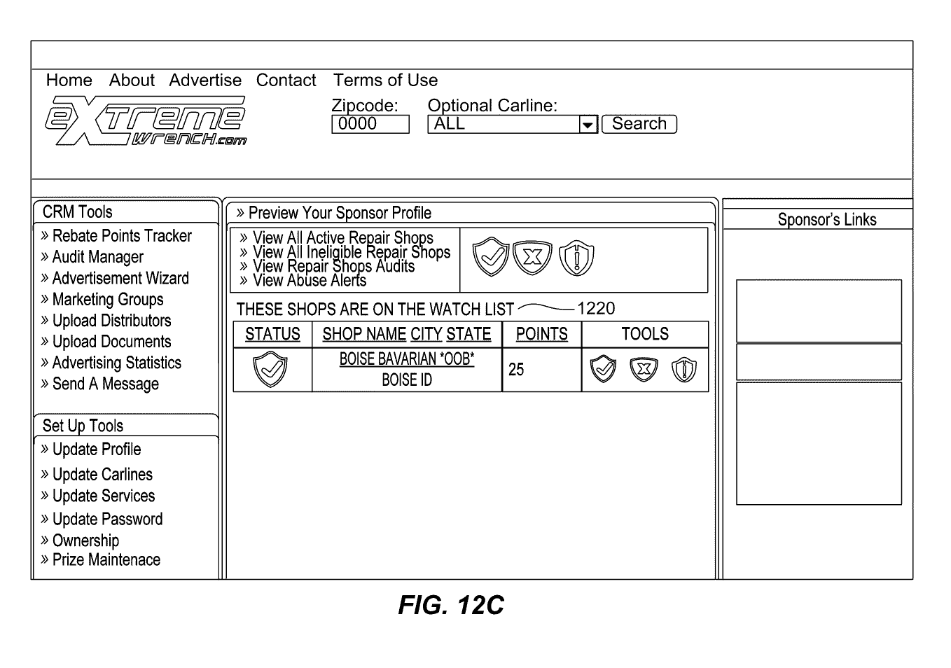

The reward credit management system 100 may have an audit manager 140 to allow the first participant 120a-n to audit the second participants 126a-n to prevent fraud and abuse as further discussed below with reference to FIGS. 11 and 12A-12C. An advertisement manager 142 may also be used to allow the first participant 120a-n to distribute their advertisements to specific territories, customers, states, industries, or the like as further discussed with reference to FIGS. 6A-6I. Although embodiments are described and illustrated utilizing separate servers, such as the advertising manager, audit manager, and the like, it will now be known that the embodiments may be carried out by a single server.

In the reward credit management system 100 shown in FIG. 1, the first participant 120a-n may transmit a list of product information 128a-n and its associated product code 130a-n to the reward credit management site 102 for storage on the reward database 104. Although illustrated and described as being stored on the reward database 104, this is not intended to be limiting as the product information, associated product code, and the like may be stored on another database. The association between the product 128a-n and product codes 130a-n as well as the first participant 120a-n may be recorded in the participation account 110. The product code 130a-n may be a Universal Product Code (UPC), coupon code, or any other symbol or indicia. The product code 130a-n may be pre-printed on the product, packaging, or container of the product or may be affixed to the product, packaging, or container of the product, such as a sticker. The user of a sticker may be more cost effective for products with pre-existing manufacturing system. In one embodiment, there is a unique product code for each product or service. In another embodiment, there may be a single unique product code for a set of identical products or services. In still another embodiment, there may be a single unique product code for a set of products or services, such as a bundles set of products or services.

The first participant 120a-n may purchase reward credits from the reward credit management site 102. In one embodiment, the first participant 120a-n may assign an associated reward credit 108 for each of the products 128a-n. In another embodiment, reward credit management site 102 may assign an associated reward credit 108 for each of the products 128a-n. The first participant 120a-n may then distribute their products 128a-n to second clients 126a-n.

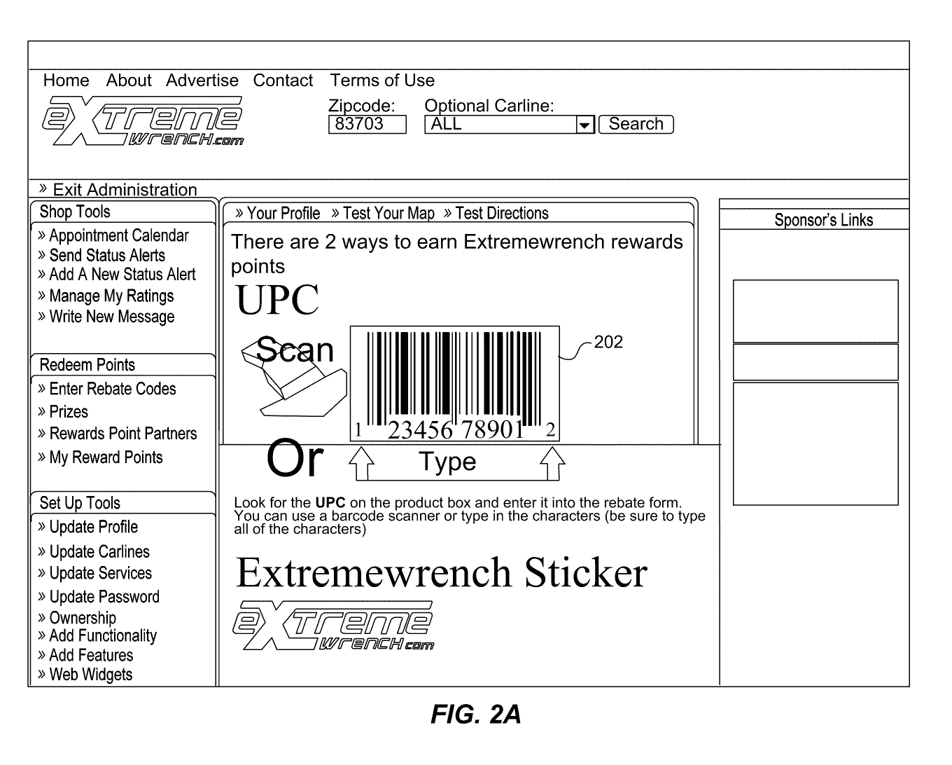

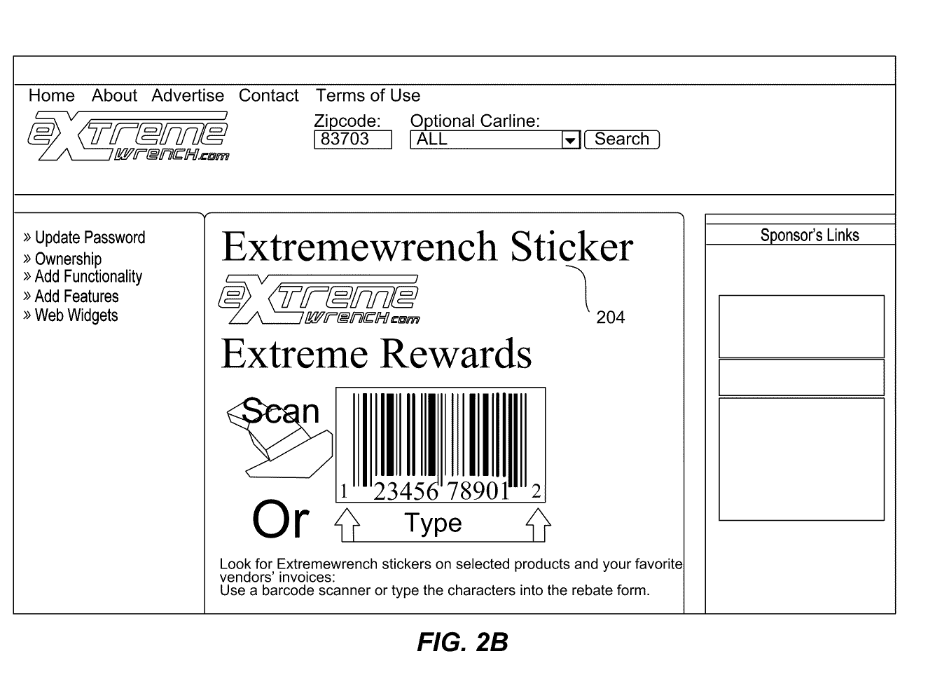

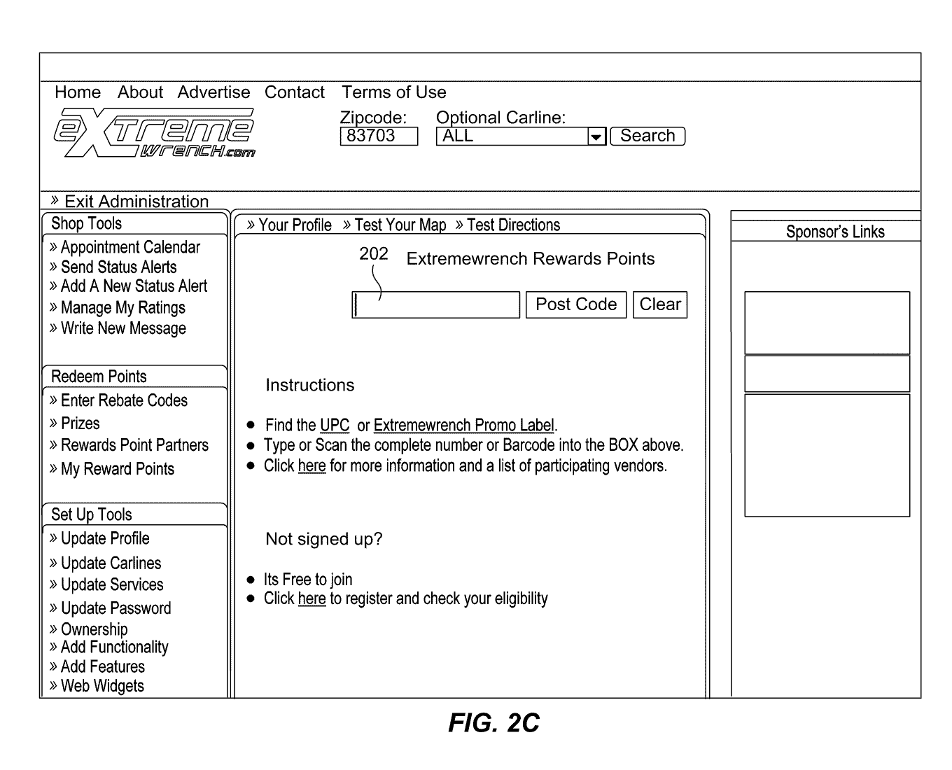

FIGS. 2A-2C illustrate example screen shots for the submission of a redemption request. Once second participants purchase the products from first participants, second participants may submit a redemption request to the reward credit management site. The redemption request may include the product code as illustrated in FIGS. 2A and 2B. The product code may be obtained from the product itself, packaging, or container of the product purchased from the first participant. The product code may be a UPC 202, a coupon code, or any other symbol or indicia. The product code may be pre-printed on the product or the packaging or container of the product or may be a affixed to the product, packaging, or container of the product, such as a sticker 204.

As illustrated in FIG. 2C, the participant may transmit the redemption request by scanning or manually inputting the UPC, bar code, coupon code, or any other symbol or indicia into the product code receiving area 202.

Referring back to FIG. 1, the reward credit management site 102 may access the reward database 104 to process the redemption request. The reward credit management site 102 may determine whether the product code 106 of the redemption request is authorized and available. In other words, the reward credit management site 102 determines whether the product code 106 is an actual product code submitted by the first participant 120a-n and whether the product code 106 has been previously redeemed. In another embodiment, the reward credits may expire after a predetermined period of time. The predetermine period of time may be determined by the first participant 120a-n and/or determined by the reward credit management site 102. If it is determined that the product code of the redemption request is authorized and available, the appropriate reward credit 108 for the product code 106 is determined. The appropriate reward credit may then be credited to the second participant 126a-n and stored in the participant account 110 on the reward database 104. The product code 106 may then be marked, labeled, tagged, or otherwise identified as being unavailable subsequent to providing the appropriate reward credit to the second participant 126a-n.

Thereafter, prizes are available to be redeemed from the reward credit management site 102 using the reward credits. The second participant 126a-n, after accumulating sufficient reward credits, may view and purchase prizes 116 using the reward credits. The prizes may be any goods or services, such as electronic goods, trips, services, conventions, training events, and the like. The reward credit management site 102 can: 1) locate the rebate amount 118 associated with the identified prize in the rebate request and 2) the total existing reward credits the second participant 126a-n has accumulated from the participant account 110. It is then determined whether the existing reward credit is equal to or greater than the rebate amount associated with the identified prize in the rebate request. If the existing reward credit is equal to or greater than the rebate amount associated with the identified prize in the rebate request, the second participant 126a-n may receive the identified prize.

The reward credit management system 100 allows for a more efficient and cost-effective manner to manage reward credits and/or coupons. The system 100 reduces the use of manpower and time that is required for current systems to redeem credits or coupons. Furthermore, customers are able to obtain and receive their reward credits instantaneously. Moreover, the system 100 allows the first participant 120a-n to dynamically and instantly make changes, view redeemed points, determine who and where to distribute their products, where to strategically advertise their goods and/or services, and the like. Additionally, as further described below with reference to FIGS. 6A-6F, the system 100 allows the first participant 120a-n to track their goods and services, limit the reward credits to a specific group of customers and/or territory, limit the time frame for use of the product codes, and to obtain valuable marketing and customer information that is not currently available with current coupons systems.

The submission of the rebate requests or redemption request as well as the purchase of prizes using the reward credits can be achieved over a data network 124. In other words, the submission of requests and purchase of prizes can be achieved online. The purchase of prizes online can also be referred to as electronic commerce (e-commerce). In one embodiment, the data network 124 includes at least a portion of the Internet. The participants 120a-n, 126a-n can vary with application but generally are computing devices that have memory storage. Often, the participants 120a-n, 126a-n are personal computers or other computing devices that are capable of storing and presenting information, such as the list of prizes, to their users. The connections through the data network 124 between the reward credit management site 102 and the participants 120a-n, 126a-n can be through secure connections, such as Secure Sockets Layer (SSL).

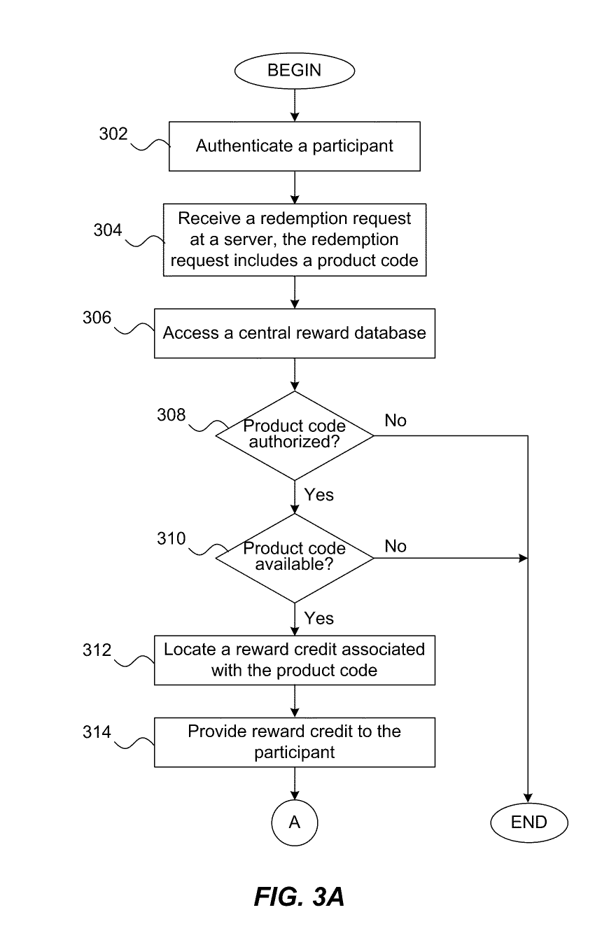

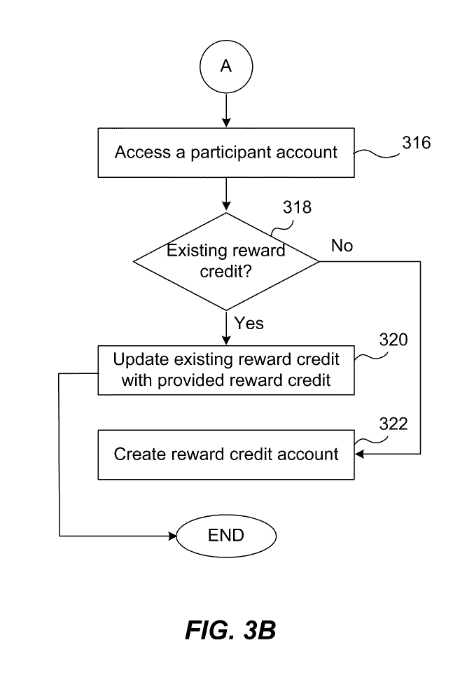

FIGS. 3A and 3B illustrate flow diagrams of an example method for redeeming reward credits. Referring to FIG. 3A, once a participant accesses the reward credit management site, the participant may be authenticated at 302. The participant may be authenticated in any known manner, such as through the use of passwords, codes, and the like. This ensures that the participant is a registered participant and allows the participant to access their own account information in the reward database.

At 304, the reward credit management site may receive a redemption request from at least one participant, typically a buyer of goods and/or services. The redemption request includes an associated product code. The product code may be associated with a service or product previously purchased by the participant. The reward credit management site may then access a reward database at 306 to determine if the product code is authorized at 308 and to determine if the product code is available at 310. In other words, it is determined whether the product code is an actual product code submitted by another participant and whether the product code has been previously redeemed.

If it is determined that the product code is authorized and available, the reward credit associated with the product code is located at 312. The reward credit may be provided to the participant at 314. The product code may then be marked as unavailable subsequent to providing the appropriate reward credit to the participant. Referring to FIG. 3B, the participant account may be accessed at 316 to determine whether the participant has an existing reward credit at 318. If an existing reward credit is located at 318, it is updated with the provided reward credit at 320. In other words, the participant accumulates reward credits such that the provided reward credit from step 314 may be added to the existing reward credit. If no existing reward credit is located at 318, a reward credit account may be created for the participant and funded with the provided reward credit from step 314. The reward credits may be recorded in the participant's account.

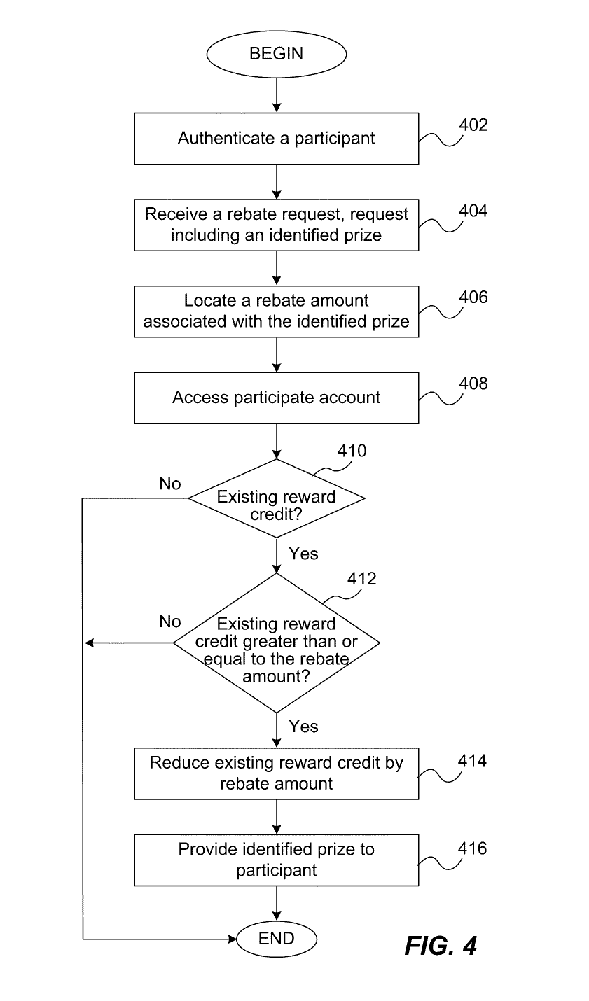

FIG. 4 illustrates a flow diagram of an example method for purchasing a prize using reward credits. Once a participant accesses the reward credit management site, the participant may be authenticated at 402. The participant may be authenticated in any known manner, such as through the use of passwords, codes, and the like. This ensures that the participant is a registered participant and allows the participant to access their own account and information.

A rebate request including an identified prize may be received at 404. The prize may be redeemed using existing reward credits the participant may have accumulated. A rebate amount for the identified prize in the rebate request may be located at 406. Once located, the participant account may be accessed at 408 to determine whether the participant has an existing reward credit at 410. If an existing reward credit is located at 410, a determination is made as to whether the existing reward credit is greater than or equal to the rebate amount at 412. If there is sufficient reward credits to purchase the prize at 412, the participant's reward credit account is updated and reduced by the rebate amount at 414. In other words, the reward credits of the participant is reduced by the rebate amount required to purchase or redeem the prize. The prize may then be provided to the participant at 416.

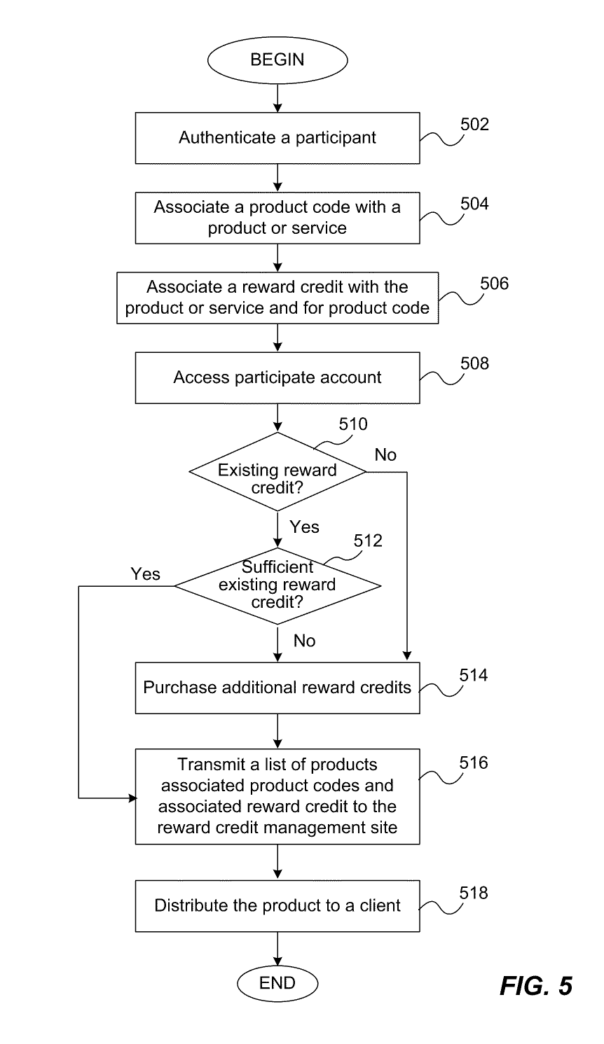

FIG. 5 illustrates a flow diagram of an example method for obtaining reward credits by a seller. Once a participant accesses the reward credit management site, the participant may be authenticated at 502. The participant may be a manufacturer, distributor, vender or any other participant which provides goods or services to customers. The goods or services may be associated with a product code at 504. In one embodiment, the participant may also associate a reward credit with the product or services and/or the product code at 506. In other words, the product may be associated with both a product code and a reward credit amount.

The participant may access their account at 508 to determine whether they have an existing reward credit amount at 510. If they have an existing reward credit amount at 510, a determination is made whether there is sufficient reward credits to use for the reward credit amounts associated with each of the goods or services in step 506. If the participant does not have an existing reward credit amount at 510 or sufficient existing reward credits at 512, then the participant may be required to purchase additional reward credits at 514.

If sufficient reward credits are purchased at 514 or there is sufficient existing reward credits at 512, a list of products, associated product code, and associated reward credits are transmitted to the reward credit management site at 516. The list may be stored in the reward database. The participant may then distribute the goods and/or services for purchase by clients at 518.

FIGS. 6A-6I illustrate example screen shots for managing reward credits. The reward credit management site allows a participant to track and obtain valuable marketing and customer information. FIG. 6A illustrates an example screen shot for tracking reward credits. The number of reward points purchased 602 by the participant 604 as well as the points that were redeemed 606 may be presented to the participant. Additionally, a final amount of points available 608 may also be presented.

Referring to FIG. 6B, the participant may use the reward credit management site to limit the reward credits to a specific group of customers, territory, and/or limit the time frame for use of the product codes. For example, the participant may create product codes and reward credits by campaign. The products 610 may be specified as well as a time frame or date 612 within which each of the reward credits for the products 610 may be redeemed. For example, the reward credits for gloves may only be redeemed between Jun. 10, 2009 and Dec. 31, 2009. Additionally, the total number of points that have been redeemed 614 by customers for a particular product may be presented. Additional information, such as campaign my state, region, and item may also be presented as graphs 616 as further illustrated with reference to FIGS. 6D-6F.

FIG. 6C illustrates an example screen shot of reward points redeemed by customer. A list of customers 618, the customer region 620, city 622, and state 624 may be analyzed or summarized and presented to the participant. The total number of reward points redeemed 626 by each customer may also be presented.

FIG. 6D illustrates an example screen shot of reward points redeemed by date. The information analyzed and recorded by the reward credit management site may be presented in any known format, such as a graphical representation as illustrated in FIG. 6D. The number of reward points redeemed 628 by date 630 may be presented in a graphical representation. FIG. 6E illustrates an example screen shot of reward points redeemed by state. The number of reward points redeemed 632 by state 634 may also be presented in a graphical representation. FIG. 6F illustrates an example screen shot of reward points redeemed by product. The number of reward points redeemed 636 by product 638 may also be presented in a graphical representation. Although the product 638 is listed using of the product codes, the actual product name may also be used.

FIG. 6G illustrates a screen shot of an advertisement manager presenting various advertisement options to the participant. An advertisement may be targeted to specific groups, shops, companies, territories, or the like. The advertisement manager may present a list of advertising options 670 to the participant such as creating marketing groups 672. As illustrated in FIG. 6H, the participant may use the advertisement manager to manage the advertising of their goods and services. The participant may be asked to submit information such as the name of the campaign 640. The participant may also target the advertisement to a specific audience 642, such as by car types a customer may service, specific groups (as described with reference to FIG. 6I), or by territory. The start date of the advertisement and the number of redemption points to be distributed may also be limited via the display control 644. In another embodiment, the participant may include a link 646 in the advertisement to direct the customer to another website with more detailed information when the customer clicks on the advertisement.

To distribute the advertisement to specific groups, customers, and/or create marketing groups, the participant may upload a list of groups and/or customers as illustrated in FIG. 6I. In one embodiment, the participant may upload a spread sheet 650 with information about each group and/or customer and the advertisement manager will analyze and record the information. This allows for an easy and user friendly way for the participant to create advertisement groups, campaigns, and the like.

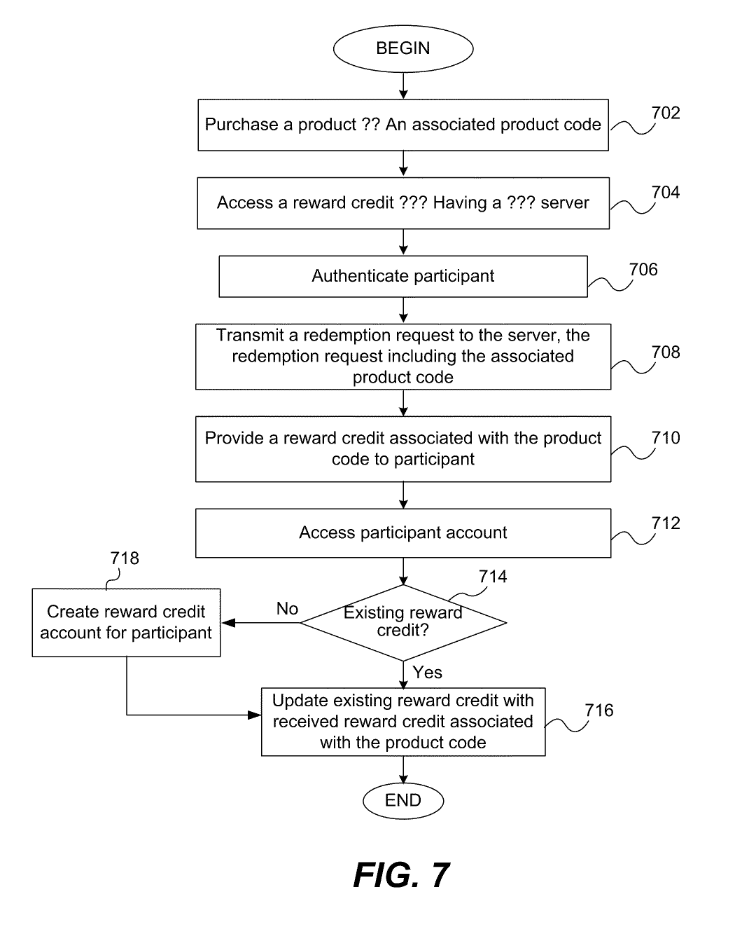

FIG. 7 illustrates a flow chart of an example method for redeeming reward credits. A participant may purchase a product (or service) having an associated product code at 702. The product code may be pre-printed on the product, packaging, or container of the product or may be a affixed to the product, packaging, or container of the product, such as a sticker. With services, the product code may be provided on a coupon presented to the participant. The participant may then access the reward credit management site having a central server at 704. In one embodiment, the reward credit management site may be a server. Once a participant accesses the reward credit management site, the participant may be authenticated at 706.

A redemption request having the associated product code may be transmitted to the server at 708. The product code may be a UPC symbol, indicia, coupon code, or that like that is scanned or manually entered by the participant. The reward credit associated with the product code may be provided to the participant at 710.

The participant account may be accessed at 712 to determine whether the participant has an existing reward credit at 714. If no existing reward credit is located at 714, a reward credit account may be created for the participant at 718. If an existing reward credit is located at 714 or the reward credit account is created at 718, the account is updated with the provided reward credit from step 710 at 716. In other words, the participant accumulates reward credits such that the provided reward credit may be added to the existing or created reward credit amount.

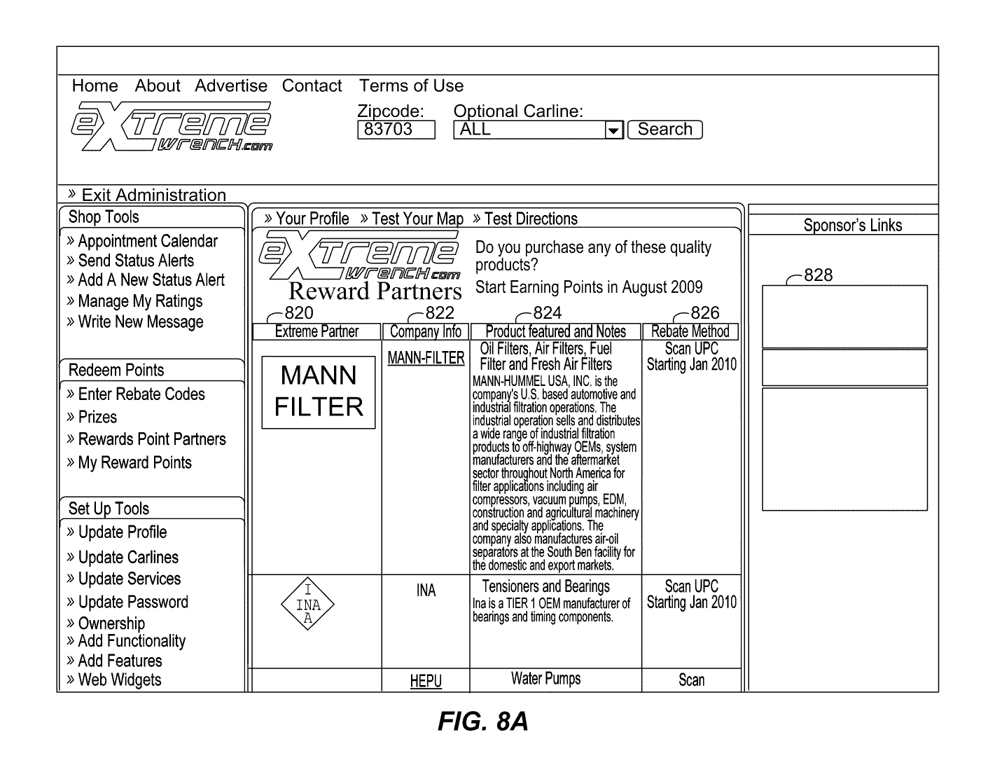

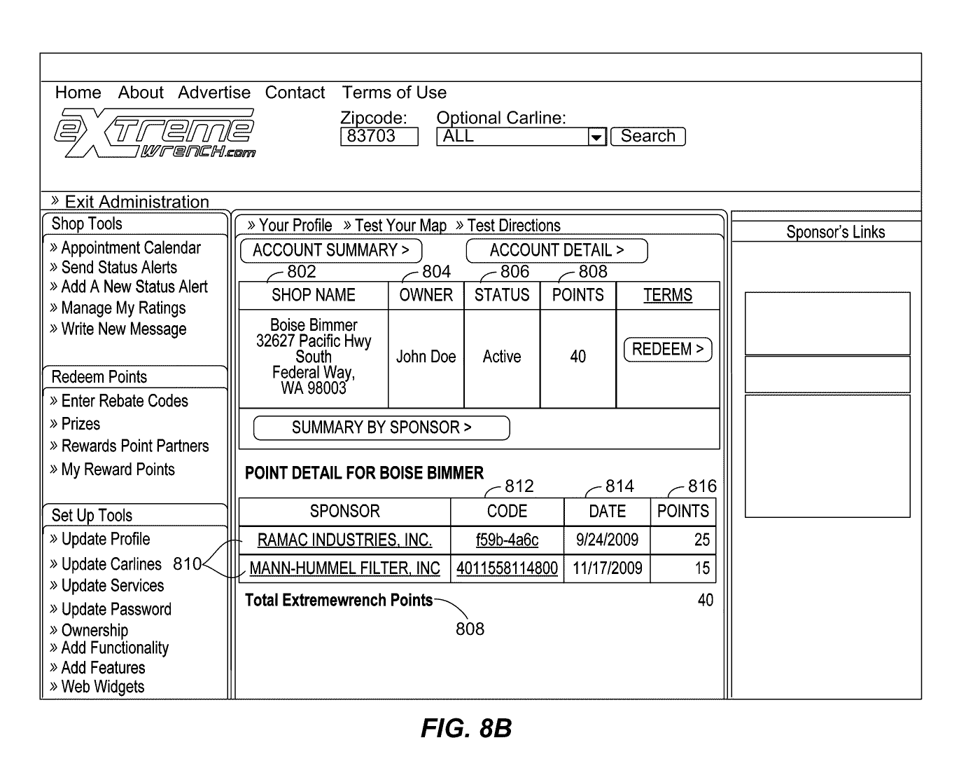

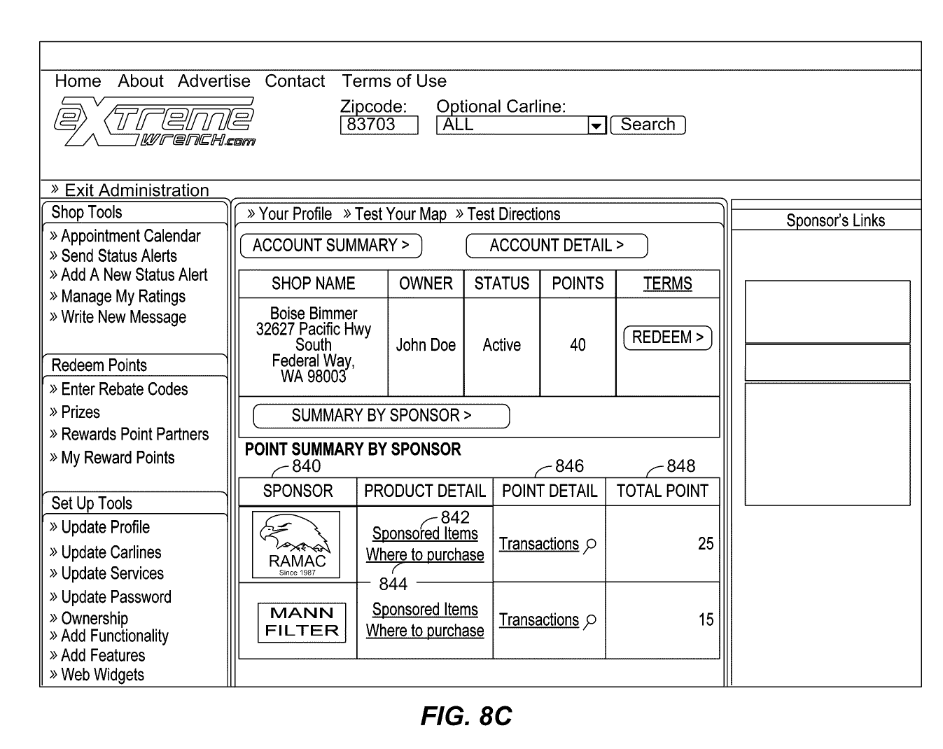

FIGS. 8A-8C illustrate example screen shots for redeeming reward credits by a customer. The reward credit management site allows a participant, such as a customer or company purchasing products, to track and obtain information about the products and reward points. For example, as illustrated in FIG. 8A, a list of products and associated manufacturers or distributors may be presented and viewed by the customer. The manufacturer or distributor 820 may be listed and presented with information about the company 822, the associated product 824, and instructions on how to redeem the reward points 826. Although presented as a list, this is not intended to be limiting as the list of manufacturers or distributors may also be displayed in any known manner, such as vertically displayed with company indicia on a side 828 of the display, as also illustrated in FIGS. 8B and 8C. In one embodiment, the customer may obtain detailed information about the manufacturer or product, by clicking on the company indicia and directed to the appropriate website page.

FIG. 8B illustrates an example screen shot illustrating a customer or participant account. The customer account may include the customer name and address 802, the owner name 804, the customer status 806 e.g. an active or inactive state (as further described with reference to FIGS. 11 and 12A-C), and the total number of reward credits obtained 808. The participant account may also include a summary of the redeemed points. For example, each product code 812 may be listed with the company name 810 or the company from which the product was purchased and/or manufactured from, the date 814 the reward points were redeemed, and the number of reward points redeemed for each product 816.

FIG. 8C illustrates another example screen shot illustrating a customer or participant account. A list of manufacturers or distributors may be listed at 840 along with a link to the list of products that may be redeemed for reward points 842 and information on where to purchase the products 844. The customer may also view their points or transactions details 846 and the total number of reward points redeemed 848.

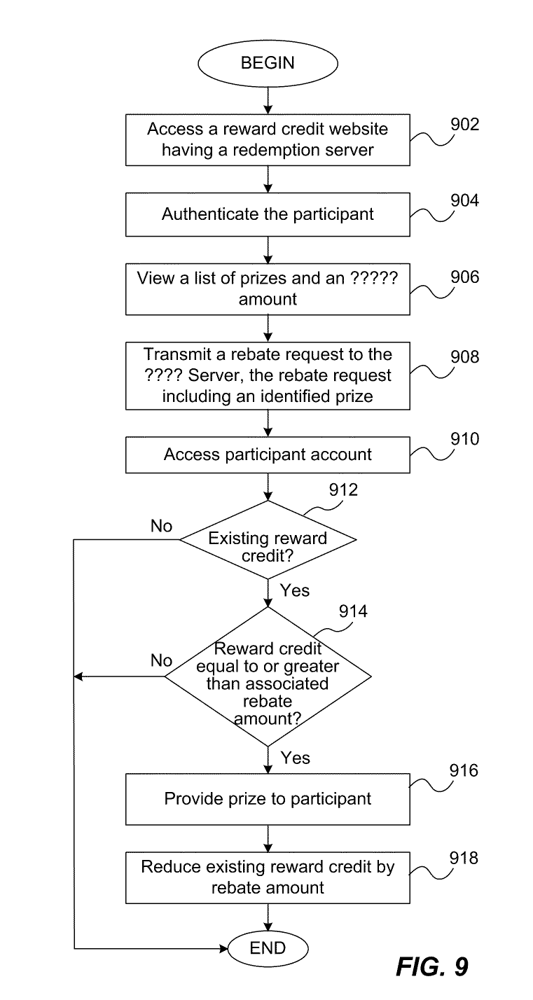

FIG. 9 illustrates a flow chart of an example method for redeeming a prize using reward credits. The participant may access a reward credit management website having a redemption server at 902. The participant may be any participant, such as a consumer, shop owner, or company, that purchased a product with an associated product code to be redeemed for reward credits. Once a participant accesses the reward credit management site, the participant may be authenticated at 904. The participant may view of list of prizes and an associated rebate amount for each prize at 906. Once the participant selects a prize, the participant may identify and elect to purchase the prize by redeeming reward points. A rebate request may be transmitted to the redemption server, the rebate request including an identified prize at 908. The participant account may be accessed at 910 to determine if the participant has existing reward credits at 912. If the client has existing reward credits, a determination is made as to whether the existing reward credit is equal to or greater than the rebate amount at 914 associated with the identified prize in the rebate request. If the existing reward credit is equal to or greater than the rebate amount associated with the identified prize in the rebate request at 914, the participant may be provided the identified prize at 916. The participant's existing reward credits may also be reduced by the rebate amount associated with the identified prize at 918.

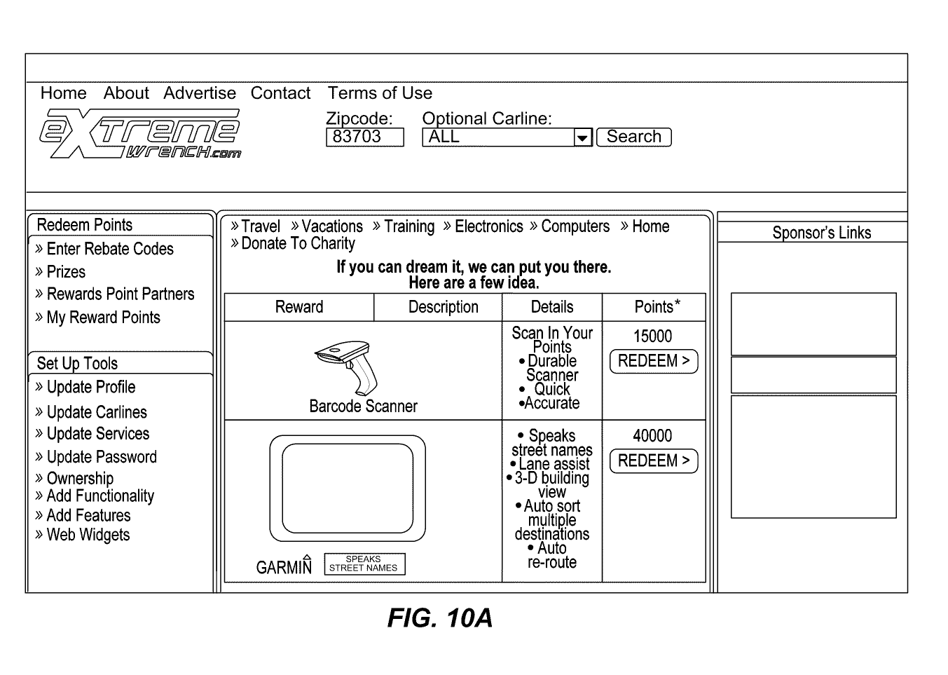

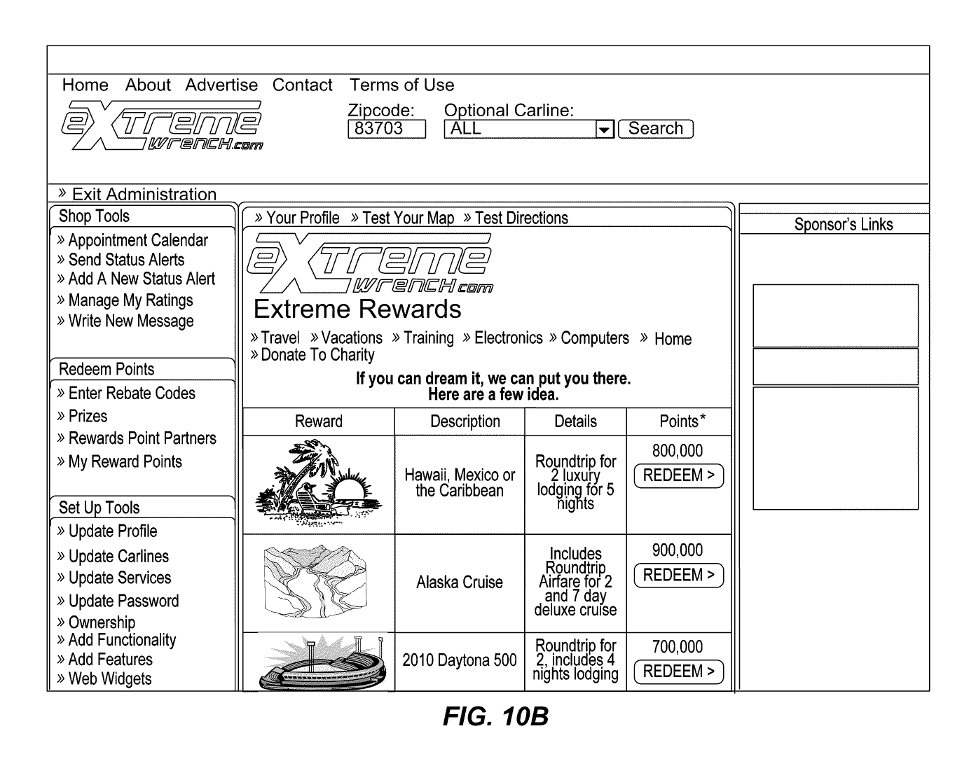

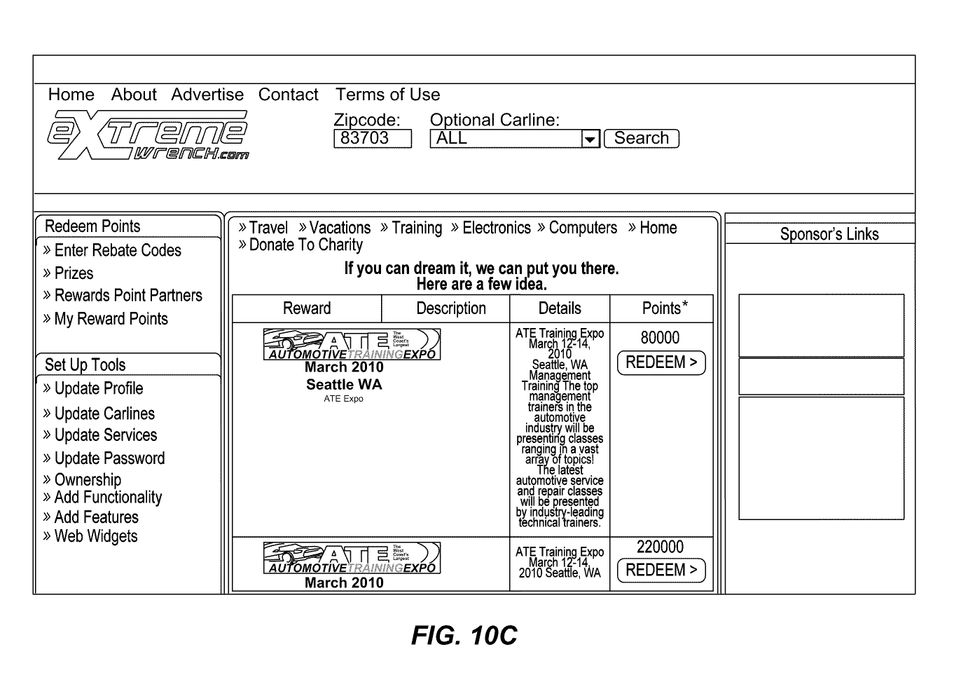

FIGS. 10A-10C illustrate screen shots of example prizes available for redemption with reward points. Reward points may be redeemed for any products, services, converted to cash and donated to charity, training, seminars, and the like. In one embodiment, as illustrated in FIG. 10A, the reward points may be redeemed for electronic goods. In another embodiment, as illustrated in FIG. 10B, the reward points may be redeemed for trips. In yet another embodiment, as illustrated in FIG. 10C, the reward points may be redeemed for seminars and training events.

FIG. 11 illustrates a flow chart of an example method to detect reward credit redemption fraud. The reward credit management site having an audit manager may allow a participant, such as a manufacturer, distributor, or any other participant that provides goods or services to customers, to audit customers to prevent abuse and fraudulent reward point redemption activities. For example, customers may attempt to input multiple product codes for the purchase of a single product. In another example, a customer may attempt to input the product code for a product that the customer did not purchase.

Once a participant accesses the reward credit management site at 1102, the participant may be authenticated at 1104. The participant may determine if there are fraudulent or suspicious activities in a customer account at 1106. For example, if the same product code is used for a plurality of identical products, a customer may submit multiple redemption requests using the same product code, yet only bought one of the products. The manufacturer will be given the impression that the customer bought several products, yet in reality, the customer only bought one of the products. In another example, a customer may submit a redemption request using a product code obtained from a product packaging without actually having bought the product.

If the participant determines that fraudulent or suspicious activities are present, the participant may decide to audit the customer account at 1108 via the audit manager. When being audited, the customer may not submit any redemption or rebate requests to the reward credit management site, the status of the customer may be “inactivated”, and the reward credits may be frozen so that the customer may not use them. The customer must then transmit proof of purchase of the goods and may do so by submitting proof of purchase UPC codes from the product packaging or container, receipt of purchase, purchase invoices, and the like.

If the customer is not able to submit evidence of purchase of the goods or services and receives an unfavorable audit at 1110, any reward credits provided to the customer may be reversed at 1112 and returned to the participant. The customer account may then be marked with an unfavorable tag, label, status icon, or any other indicia or marking at 1114. The rewards credit management site may also inform other participants (e.g. seller of goods and services) that the customer is marked with an unfavorable tag at 1116.

FIGS. 12A-12C illustrate example screen shots for an audit of a customer. FIG. 12A is an example of a sample audit of a company named World Class Car Care 1202. The company may be provided with instructions such as what evidence or proof must be submitted 1204, deadline for complying and submitting the evidence 1206, the contact person for submission of the evidence 1208, and the products for which the evidence or proof must be submitted 1210.

As illustrated in FIG. 12B, the participant may be presented with a list of customers 1212 who have purchased their product and redeemed reward credits 1214. The list may also include a status icon or tag 1216 to indicate whether the customer is in good standing, undergoing an audit, or if the customer has had an unfavorable audit. As illustrated in FIG. 12B, all customers or shop owners are marked with a status tag to indicate that they are all in good standing. However, the participant, may use the tools 1218 and click on an icon to elect to conduct an audit on any of the customers 1212. In one embodiment, customers that have had an unfavorable audit which could not be substantiated (e.g. documents were lost in a fire or flood) may simply be placed on a “watch list” 1220 as illustrated in FIG. 12C.

FIGS. 13A-13B illustrate example screen shots of customer information. To collect information about each participant (e.g. customers and buyers) who redeems reward credits, the reward credit management site allows each participant to submit relevant information. In one embodiment, the participant information may be stored in the rewards database as illustrated in FIG. 1. Although illustrated with customers being shop owners that purchase automotive goods, this is not intended to be limiting as any other retail customer and buyer may redeem reward credits for any type of goods and services. For example, as illustrated in FIG. 13A, the participant may submit information on the carlines 1302 the shop repairs. The information may be submitted based on the type of car and the percentage of business for each type of car. In another example, as illustrated in FIG. 13B, the various services 1304 the shop provides may be submitted.

FIG. 14 is an exemplary computer system 1400 suitable for use with at least one embodiment of the invention. The methods, processes and/or graphical user interfaces discussed above can be provided by a computer system. The computer system 1400 includes a display monitor 1402 having a single or multi-screen display 1404 (or multiple displays), a cabinet 1406, a keyboard 1408, and a mouse 1410. The mouse 1410 is representative of one type of pointing device. The cabinet 1406 houses a processing unit (or processor), system memory and a hard drive (not shown). The cabinet 1406 also houses a drive 1412, such as a DVD, CD-ROM or floppy drive. The drive 1412 can also be a removable hard drive, a Flash or EEPROM device, etc. Regardless, the drive 1412 may be utilized to store and retrieve software programs incorporating computer code that implements some or all aspects of the invention, data for use with the invention, and the like. Although CD-ROM 1414 is shown as an exemplary computer readable storage medium, other computer readable storage media including floppy disk, tape, Flash or EEPROM memory, memory card, system memory, and hard drive may be utilized. In one implementation, a software program for the computer system 1400 is provided in the system memory, the hard drive, the drive 1412, the CD-ROM 1414 or other computer readable storage medium and serves to incorporate the computer code that implements some or all aspects of the invention.

FIG. 15 is a block diagram of an example computing system. The computing system 1500 may be the reward credit management site of FIG. 1, redemption server of FIG. 1, or any other server or computing device used to carry out the various embodiments disclosed herein. The computing system 1500 may include a processor 1502 that pertains to a microprocessor or controller for controlling the overall operation of the computing system 1500. The computing system 1500 stores information, such as a list of products, associated product codes, associated reward credits, participant account, and participant information in a file system 1504 and a cache 1506. The file system 1504 is, typically, a storage disk or a plurality of disks. The file system 1504 typically provides high capacity storage capability for the computing system 1500. However, since the access time to the file system 1504 is relatively slow, the computing system 1500 can also include a cache 1506. The cache 1506 is, for example, Random-Access Memory (RAM) provided by semiconductor memory. The relative access time to the cache 1506 is substantially shorter than for the file system 1504. However, the cache 1506 does not have the large storage capacity of the file system 1504. Further, the file system 1504, when active, consumes more power than does the cache 1506. The computing system 1500 also includes a RAM 1520 and a Read-Only Memory (ROM) 1522. The ROM 1522 can store programs, utilities or processes to be executed in a non-volatile manner. The RAM 1520 provides volatile data storage, such as for the cache 1506.

The computing system 1500 also includes a user input device 1508 that allows a user of the computing system 1500 to interact with the computing system 1500. For example, the user input device 1508 can take a variety of forms, such as a button, keypad, dial, and the like. Still further, the computing system 1500 includes a display 1510 (screen display) that can be controlled by the processor 1502 to display information, such as a list of prize, to the user. A data bus 1511 can facilitate data transfer between at least the file system 1504, the cache 1506, the processor 1502, and the CODEC 1512.

In one embodiment, the computing system 1500 serves to store a plurality of prizes and its associated rebate amount in the file system 1504. When a user desires to have the computing system display a particular category of prizes, such as electronics, the prizes may be displayed on the display 1510.

The computing system 1500 may also include a network/bus interface 1516 that couples to a data link 1518. The data link 1518 allows the computing system 1500 to couple to a host computer or data network, such as the Internet. The data link 1518 can be provided over a wired connection or a wireless connection. In the case of a wireless connection, the network/bus interface 1516 can include a wireless transceiver.

While embodiments and applications have been shown and described, it would be apparent to those skilled in the art having the benefit of this disclosure that many more modifications than mentioned above are possible without departing from the inventive concepts herein. For example, any goods or services may be utilized other than automotive goods.

What is claimed is:

1. A system for managing reward credits, comprising:
a central reward database configured to record a predetermined set of product codes, a reward credit associated with each product code in the predetermined set of product codes, and at least one participant account associated with the predetermined set of product codes; and
a server configured to:
(a) receive a redemption request from at least one registered participant, the redemption request including a product code, wherein the product code is provided on a product or product container;
(b) access the central reward database to determine whether the product code of the redemption request is authorized and available;
(c) determine the appropriate reward credit for the product code if it is determined that the product code of the redemption request is authorized and available; and
(d) provide the appropriate reward credit to the at least one registered participant.

2. The system of claim 1, wherein the product code is a scanned UPC symbol, indicia, or coupon.

3. The system of claim 1, wherein the central reward database is configured to record shop information associated with each of the at least one participant account.

4. The system of claim 1, wherein the appropriate reward credit is credited to the at least one participant account associated with the registered participant.

5. The system of claim 1, wherein the server is configured to:
(e) determine if the at least one registered participant has an existing reward credit; and
(f) update the existing reward credit with the appropriate reward credit if it is determined that the at least one registered participant has an existing reward credit.

6. The system of claim 1, wherein the server is configured to authenticate the at least one registered participant subsequent to receiving the redemption request.

7. The system of claim 1, wherein the product or product container are associated with automotive goods.

8. The system of claim 1, wherein the server is configured to mark the product code of the redemption request as unavailable subsequent to providing the appropriate reward credit to the at least one registered participant.

9. The system of claim 5, wherein the a server configured to:
(g) receive a rebate request from the at least one registered participant, the rebate request including an identified prize;
(h) locate, at a redemption server, a rebate amount associated with the identified prize in the rebate request;
(i) determine if the existing reward credit is equal to or greater than the rebate amount;
(i) reduce the existing reward credit by the rebate amount if it the existing reward credit is equal to or greater than the rebate amount; and
(k) provide the identified prize to the registered participant.

10. A method for redeeming reward credits, comprising:
receiving, at a server, a redemption request from at least one registered participant, the redemption request having a product code associated with a product or a product container;
accessing a central reward database to:
determining if the product code is authorized and available; and
locating a reward credit associated with the product code if the determining determined that the product code is authorized and available; and
providing the reward credit to the at least one registered participant.

11. The method of claim 10, further comprising:
determining if there is an existing reward credit for the at least one registered participant; and
updating the existing reward credit with the provided reward credit if it is determined that there is an existing reward credit for the at least one registered participant.

12. The method of claim 11, further comprising:
receiving, at a redemption server, a rebate request from the at least one registered participant, the rebate request including an identified prize;
locating a rebate amount associated with the identified prize in the rebate request;
determining if the existing reward credit is equal to or greater than the rebate amount;
reducing the existing reward credit by the rebate amount if it the existing reward credit is equal to or greater than the rebate amount; and
providing the identified prize to the registered participant.

13. The method of claim 12, further comprising authenticating the at least one registered participant subsequent to receiving the rebate request.

14. The method of claim 10, wherein the product code is a scanned UPC symbol, indicia, or coupon.

15. The method of claim 10, further comprising authenticating the at least one registered participant subsequent to receiving the redemption request.

16. The method of claim 10, wherein the product or product container is associated with automotive goods.

17. The method of claim 10, wherein the providing further comprises marking the product code of the redemption request as unavailable.

18. A method for redeeming reward credits, comprising:
obtaining, by a registered participant, at least one product having an associated product code;
accessing a reward credit management website having a central server;
entering the associated product code for transmission to the central server;
receiving a reward credit associated with the product code.

19. The method of claim 18, further comprising transmitting a rebate request to the central server for an identified prize using the reward credit.

20. The method of claim 19, further comprising:
locating, at the central server, a rebate amount associated with the identified prize in the rebate request;
locating, an existing reward credit of the registered participant;
determining if the existing reward credit is equal to or greater than the rebate amount associated with the identified prize in the rebate request.

21. The method of claim 20, further comprising receiving the identified prize by the registered participant if it is determined that the existing reward credit is equal to or greater than the rebate amount associated with the identified prize in the rebate request.

22. The method of claim 21, further comprising reducing the existing reward credit by the rebate amount.

23. The method of claim 18, further comprising updating an existing reward credit of the registered participant based upon the reward credit.

24. The method of claim 18, wherein the entering further comprises authenticating the registered participant prior to entering the product code for transmission to the central server.

25. The method of claim 18, wherein the entering further comprises scanning a UPC symbol, indicia, or coupon.

26. The method of claim 18, wherein the at least one product is associated with automotive goods.

27. The method of claim 18, further comprising reducing an existing reward credit amount after a predetermined period of time.

28. The method of claim 18, further comprising entering shop information associated with the registered participant.

29. A program storage device readable by a machine tangibly embodying a program of instructions executable by the machine to perform a method for managing reward credits, comprising:
configuring a central reward database to recognize a predetermined set of product codes;
subsequently receiving a redemption request from a registered participant, the redemption request including a product code provided on a product or product container;
determining whether the product code of the redemption request is authorized and available;
determining the appropriate reward credit for the product code if the determining determines that the product code of the redemption request is authorized and available; and
providing the appropriate reward credit to the registered participant.

30. The device of claim 30, further comprising representing a list of a plurality of prizes and an associated rebate amount.

31. The device of claim 30, further comprising receiving a rebate request from the registered participant, the rebate request including a request to redeem an identified prize using the reward credit.

32. The method of claim 31, further comprising:
locating, at the central server, a rebate amount associated with the identified prize in the rebate request;
locating, an existing reward credit of the registered participant;
determining if the existing reward credit is equal to or greater than the rebate amount associated with the identified prize in the rebate request; and
providing the identified prize to the registered participant if the determining determines that the existing reward credit is equal to or greater than the rebate amount associated with the identified prize in the rebate request.
